(19) United States
(12) Patent Application Publication
(10) Pub. No.: US 2022/0127043 A1
(43) Pub. Date: Apr. 28, 2022

(54) REINFORCING MEMBER AND STORAGE BOX HAVING THE SAME

(71) Applicant: L&F PLASTICS, CO., LTD., Miaoli County (TW)

(72) Inventor: Mu-Chuan HSU, Miaoli County (TW)

(73) Assignee: L&F PLASTICS, CO., LTD., Miaoli County (TW)

(21) Appl. No.: 17/511,983

(22) Filed: Oct. 27, 2021

(30) Foreign Application Priority Data
Oct. 27, 2020 (TW) 109137237

(51) Int. Cl. B65D 25/20

(52) U.S. Cl. CPC B65D 25/20

(57) ABSTRACT

This patent provides a reinforcing member which is applied to a storage box. The reinforcing member is roughly in a shape of a frame, comprising a first annular structure, a second annular structure, and a positioning portion. The thickness of the second annular structure is not greater than the thickness of the first annular structure, and the second annular structure is surrounded by the first annular structure. There is a gap between the first annular structure and the second annular structure wherein the gap length of the gap is not shorter than 0.5 cm. The positioning portion is disposed in the gap. Wherein the storage box includes a box body, a bottom surface of the box body includes a positioning structure, and the positioning portion of the reinforcing member may be connected to the positioning structure.

### CROSS-REFERENCE TO RELATED PATENT APPLICATION

This application claims the benefit under 35 USC § 119 of Taiwan Patent Application No. 109137237 filed on Oct. 27, 2020, which is incorporated herein by reference in its entirety.

### FIELD OF THE DISCLOSURE

The present disclosure relates to a reinforcing member and a storage box having the same, and more particularly to a reinforcing member that provides the effect of reinforcement, collision avoidance or buffer and a storage box having the same.

### BACKGROUND

The corner of the conventional container (storage box, packing box, laundry basket, etc.) is liable to be damaged as a result of collisions, squeezing, etc. during the process of transportation. Besides, for example, but not limited to, the floor, the wall, or other furniture may also be damaged or scratched due to the collision with the said corner.

Furthermore, the conventional storage box is usually made by the integrally forming method. For manufacturers, the said method has advantages such as better production efficiency and lower manufacturing cost. However, when the corner of said conventional storage box made by the said integrally forming method gets damaged, the user may usually choose to abandon the whole storage box directly, so the conventional storage box does obviously not conform to the current environmental awareness.

Accordingly, it is an important issue about how to provide a product to strengthen the corner of the product such as a storage box to reduce the damage caused by the collision between the product and other objects such as the floor, the wall, or other furniture to extend the life of the product and other objects, and how to provide a storage box only need to replace a member for repairing whole product when the corner of the storage box gets damaged, rather than abandoning the whole storage box.

### SUMMARY

In response to the above-referenced inadequacies, the present disclosure provides a reinforcing member which is applied to a storage box. The reinforcing member is roughly in a shape of a frame. The reinforcing member comprises a first annular structure, a second annular structure, and a positioning portion. The thickness of the second annular structure is not greater than the thickness of the first annular structure, and the second annular structure is surrounded by the first annular structure. There is a gap between the first annular structure and the second annular structure wherein the gap length of the gap is not shorter than 0.5 cm. The positioning portion is disposed in the gap. The storage box includes a box body, a bottom surface of the box body includes a positioning structure, and the positioning portion of the reinforcing member may be connected to the positioning structure.

In some embodiments, the thickness of the first annular structure is between 1 cm and 5 cm.

In some embodiments, the first annular structure is roughly in a shape of a lozenge, including a boundary with a circular arc angle (circular arc angle boundary) and a boundary with a non-circular arc angle (non-circular arc angle boundary).

In some embodiments, the first annular structure has at least two circular arc angle boundaries, and the said circular arc angle boundaries are respectively arranged on one side and another side of a virtual bisector plane of the non-circular arc angle boundary.

In some embodiments, the reinforcing member is symmetrical with respect to the virtual bisector plane.

In some embodiments, at least 70% of the surface of the second annular structure is parallel to the surface of the first annular structure.

The present disclosure also provides a storage box. The storage box comprises a reinforcing member and a box body. The reinforcing member is roughly in a shape of a frame, and the reinforcing member includes a first annular structure, a second annular structure, and a positioning portion. The thickness of the second annular structure is not greater than the thickness of the first annular structure, and the second annular structure is surrounded by the first annular structure. There is a gap between the first annular structure and the second annular structure, and gap length of the gap not shorter than 0.5 cm. The positioning portion is disposed in the gap. The box body includes a bottom surface, and there is a positioning structure used to connected to the positioning portion of the reinforcing member disposed at a corner of the bottom surface. The reinforcing member is connected to the positioning structure.

In some embodiments, the storage box further comprises a fixing member, wherein the fixing member is detachably connected to the bottom surface and the fixing member is used to allow the reinforcing member to be fixed to the bottom surface.

In some embodiments, a hollow part of the reinforcing member further comprises a roller assembly.

In conclusion, the present disclosure provides a reinforcing member. The reinforcing member is roughly in a shape of a frame including a first annular structure and a second annular structure. There is a positioning portion between the first annular structure and the second annular structure. The positioning portion is used to allow the reinforcing member to be connected to or fixed to part of other articles so as to provide the effect of reinforcement, collision avoidance or buffer.

In addition, because the reinforcing member is roughly in a shape of a symmetrically lozenge, the complexity of the mold may be simplified and the efficiency of the manufacturing process may be improved.

Lastly, a circular arc angle boundary makes the bottom corner of the storage box to reduce the sharpness, improving a user's tactile sensation and dispersing the pressure created from being collided by an external force.

### BRIEF DESCRIPTION OF THE DRAWINGS

FIG. 1A is a schematic perspective view of the storage box in one embodiment of the present disclosure.

FIG. 1B is a schematic exploded view of the FIG. 1A.

FIG. 2A is a schematic perspective view of the reinforcing member in one embodiment of the present disclosure.

FIG. 2B is another schematic perspective view of the reinforcing member in one embodiment of the present disclosure.

FIG. 2C is a schematic top view of the reinforcing member in one embodiment of the present disclosure.

FIG. 3A is a schematic bottom perspective view of the storage box in one embodiment of the present disclosure.

FIG. 3B is a partial schematic exploded view of the FIG. 3A.

FIG. 3C is an enlarged schematic cross-sectional view of area marked with “a” in the FIG. 3A.

FIG. 4A is a schematic bottom view of the storage box in one embodiment of the present disclosure.

FIG. 4B is a partial schematic enlarged view of the FIG. 4A.

FIG. 5 is a schematic assembly view of the reinforcing member in one embodiment of the present disclosure.

### DETAILED DESCRIPTION

The reinforcing member and storage box having the same in the preferred embodiments of this disclosure are described below with reference to the relevant drawings. Like numbers refer to like elements throughout and different embodiments of like elements can be designated using a different number of superscript indicator apostrophes (e.g., 1′, 1″).

It is important to note that all directional terms in the embodiments of this disclosure (such as upper, lower, left, right, front, and back) are used only to explain the relative positional relationship, movement condition, and the like between components in a particular state (as shown in the accompanying drawings), and if the particular state changes, the directional terms will change accordingly.

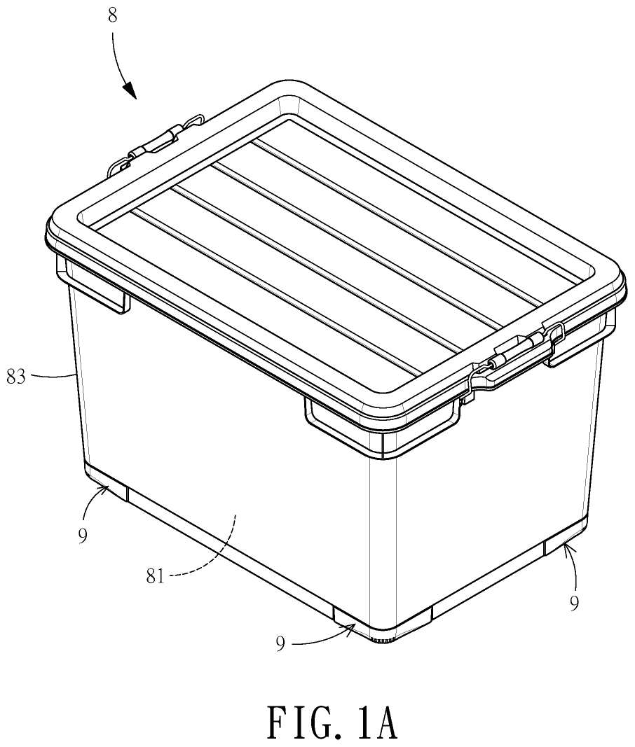

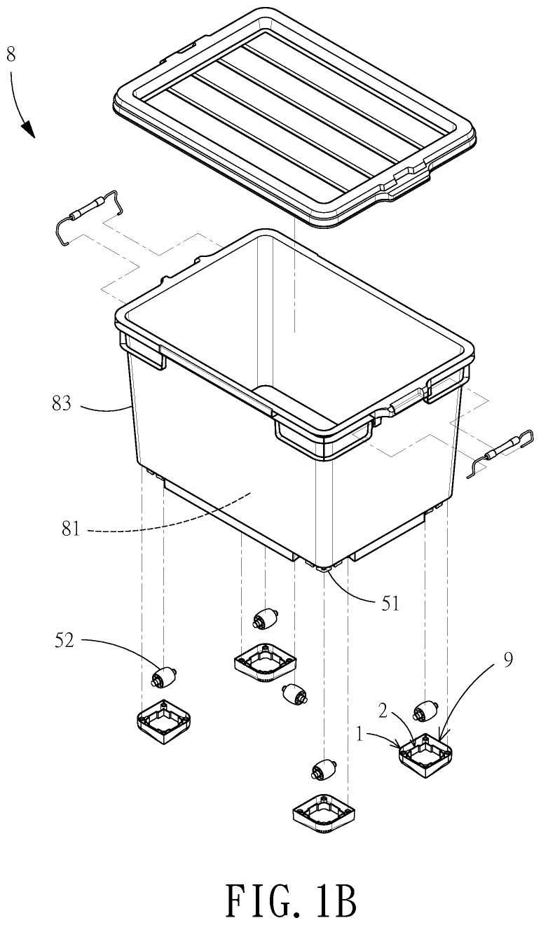

As shown in FIG. 1A and FIG. 1B, in some embodiments, the reinforcing member 9 may be connected to a specific site of an article, for example, a storage box, a suitcase, a basket or a packing box, being used to provide the effect of reinforcement, collision avoidance or buffer. In this embodiment, the reinforcing member 9 is applied to a storage box 8 and be connected to a corner of the storage box 8.

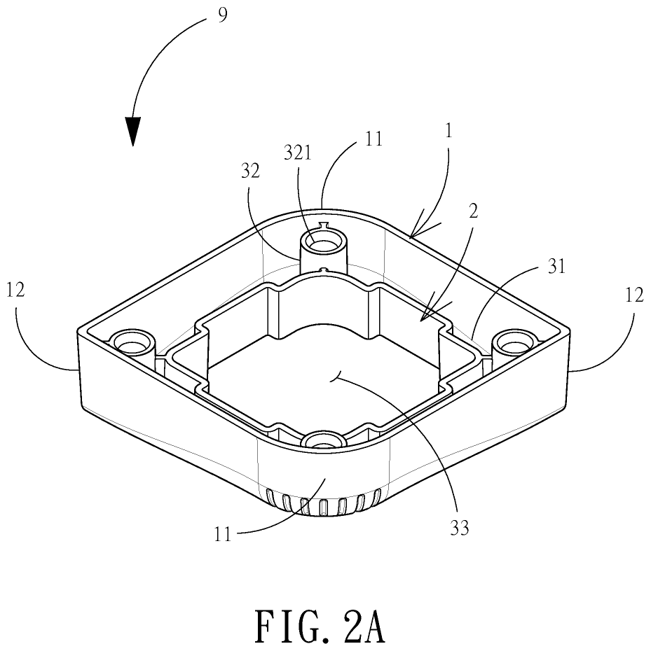

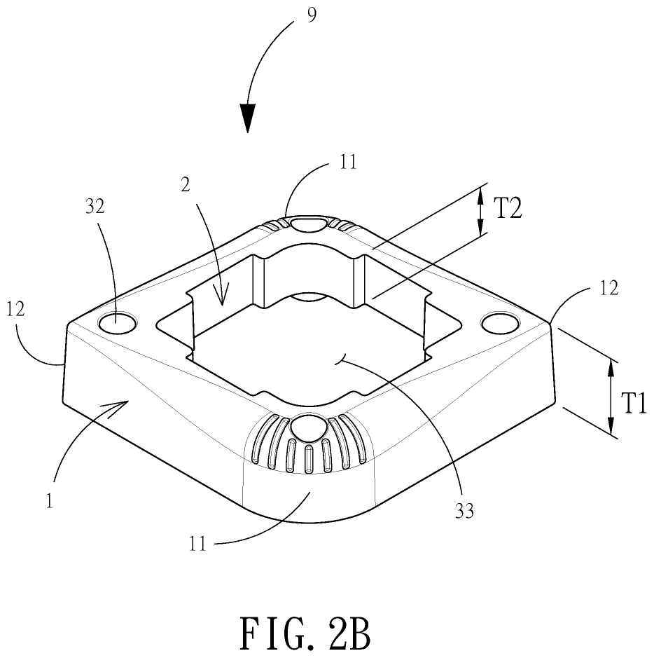

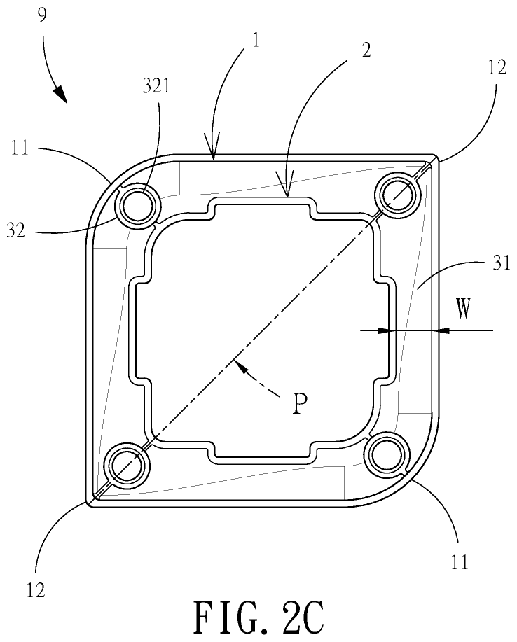

As shown in FIG. 2A to FIG. 2C, in some embodiments, the reinforcing member 9 is roughly in a shape of a frame including a first annular structure 1 and a second annular structure 2. In this embodiment, the first annular structure 1 is roughly in a shape of a frame, and the second annular structure 2 similarly is roughly in a shape of a frame. In addition, the second annular structure 2 is surrounded by the first annular structure 1, and the second annular structure 2 is located inside the first annular structure 1.

As shown in FIG. 2A to FIG. 2C, in some embodiments, the first annular structure 1 is roughly in a shape of a lozenge including a circular arc angle boundary 11 and a non-circular arc angle boundary 12. The arc angle means that the function of itself has a continuity when being placed on the plane coordinate system. Contrarily, the non-circular arc angle means that the function of itself has a discontinuity when being placed on the plane coordinate system. In some embodiments, a radius of curvature of the circular arc angle boundary 11 is 0.5, 1, 5, 10 or 30 cm, or the radius of curvature of the circular arc angle boundary 11 is in any range defined between any two of the foregoing values. In some embodiments, an angle of the non-circular arc angle boundary 12 is 15, 45, 60, 90, 120 or 135 degrees, or the angle of the non-circular arc angle boundary 12 is in any range defined between any two of the foregoing values. In this embodiment, the angle of the non-circular arc angle boundary 12 is around 90 degrees.

As shown in FIG. 2A to FIG. 2C, in some embodiments, the first annular structure 1 has at least two circular arc angle boundaries 11, and the said circular arc angle boundaries 11 are respectively arranged on one side and another side of a virtual bisector plane P (as shown in FIG. 2C) of the non-circular arc angle boundary 12. The virtual bisector plane P is a cross-section defined along the dot-and-dash line in FIG. 2C, being a virtual plane. As shown in FIG. 2C, in this embodiment, the first annular structure 1 is roughly in a shape of a lozenge, comprising two circular arc angle boundaries 11 and two non-circular arc angle boundaries 12. Wherein, the said two circular arc angle boundaries 11 are respectively arranged on one side and another side of the virtual bisector plane P, i.e., the said two circular arc angle boundaries 11 are located at angles that are not adjacent to each other.

As shown in FIG. 2A to FIG. 2C, in some embodiments, the reinforcing member 9 is generally symmetrical with respect to the virtual bisector plane P (as shown in FIG. 2C). In this embodiment, the reinforcing member 9 is symmetrical with respect to the virtual bisector plane P, and simultaneously, the reinforcing member 9 is symmetrical with respect to another virtual plane (not shown) which is perpendicular to the virtual bisector plane P. Such a symmetrical structure, for example, may simplify the complexity of the mold, increase the efficiency of the manufacturing process, and improve the convenience of assembling the reinforcing member 9 into other articles (storage boxes, tool boxes, or luggage boxes, etc.) by a user so as to avoid a wrong assembly direction, like a USB plug cannot be correctly inserted into a USB socket under a wrong assembly direction.

As shown in FIG. 2B, in some embodiments, the thickness of the first annular structure T1 is around 1, 2, 3, 4 or 5 cm, or the thickness of the first annular structure T1 is in any range defined between any two of the foregoing values. In some embodiments, the thickness of the second annular structure T2 is not greater than the thickness of the first annular structure T1. In this embodiment, the thickness of the first annular structure T1 is between 1 cm and 5 cm, and the thickness of the second annular structure T2 is not greater than the thickness of the first annular structure T1.

As shown in FIG. 2A to FIG. 2C, in some embodiments, there is a gap 31 between the first annular structure 1 and the second annular structure 2. The gap length W of the gap 31 (as shown in FIG. 2C) is around 0.5, 1, 1.5, 2, 2.5, 3, 3.5, 4, 4.5 or 5 cm, or the gap length W of the gap 31 in any range defined between any two of the foregoing values. The reinforcing member 9 is roughly in a shape of a frame as described above, and then the gap length W of the gap 31 is equivalent to the thickness of the frame. In this embodiment, the gap length W of the gap 31 is not shorter than 0.5 cm.

As shown in FIG. 2A and FIG. 2B, in some embodiments, at least 70%, 75%, 80%, 85%, 90%, 95% or 99% of the surface of the second annular structure 2 is parallel to the surface of the first annular structure 1. In this embodiment, at least 70% of the surface of the second annular structure 2 is parallel to the surface of the first annular structure 1, and the second annular structure 2 includes four indentation surfaces, two circular arc angle curved surfaces, and two non-circular arc angle surfaces. In this embodiment, the four indentation surfaces of the second annular structure 2 is parallel to the four sides of the first annular structure 1, the two circular arc angle curved surfaces of the second annular structure 2 is parallel to the two circular arc angle boundaries 11 of the first annular structure 1, and the two non-circular arc angle surfaces of the second annular structure 2 is parallel to the two non-circular arc angle boundaries 12 of the first annular structure 1.

As shown in FIG. 2A and FIG. 2B, in some embodiments, the reinforcing member 9 further comprise a positioning portion 32, wherein the positioning portion 32 is disposed in the gap 31, and the positioning portion 32 is used to allow the reinforcing member 9 to be connected to or fixed to a member of other article. In this embodiment, the positioning portion 32 is a hollow structure roughly in a shape of a cylinder. The positioning portion 32 will be described using more specific embodiment in the subsequent paragraphs.

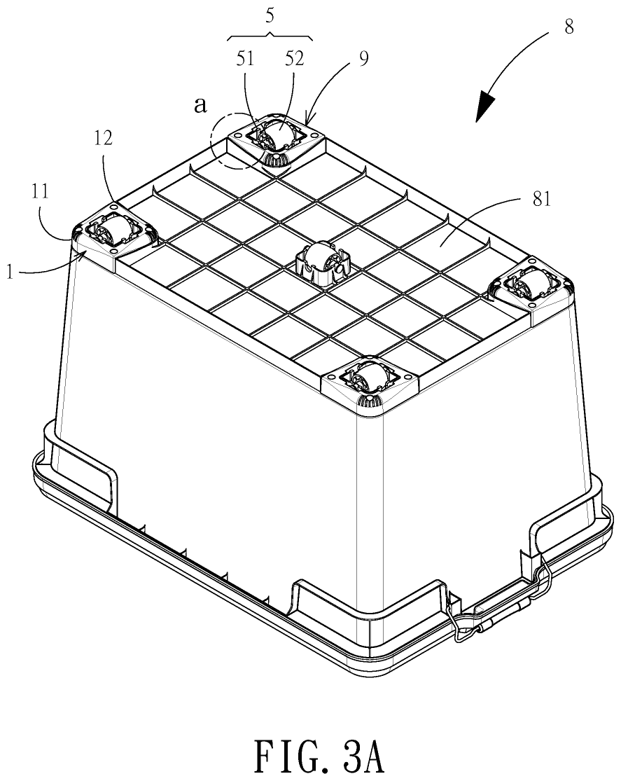

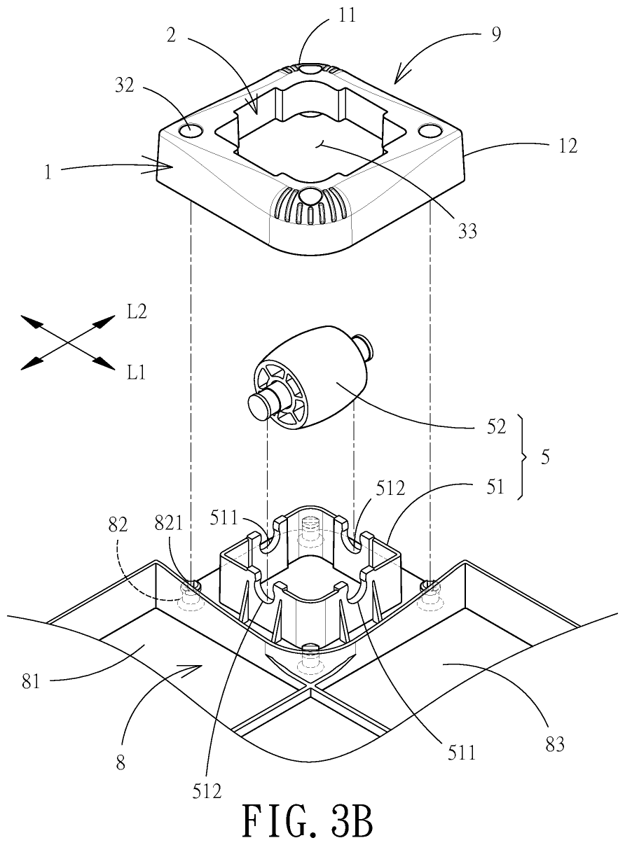

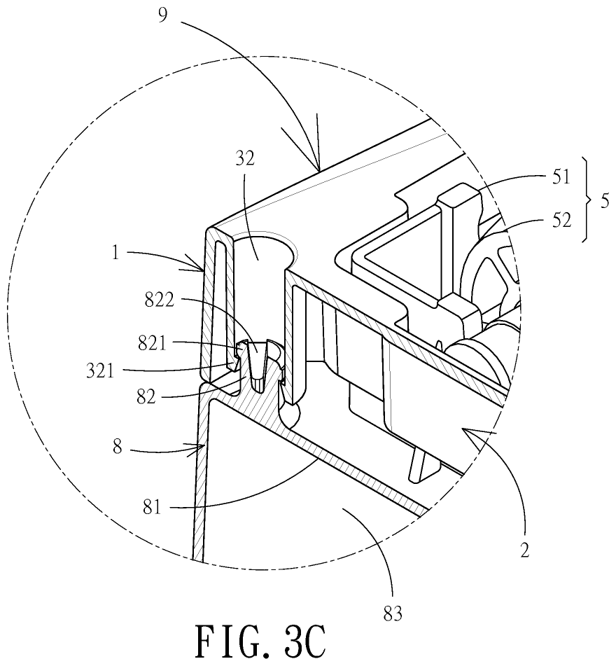

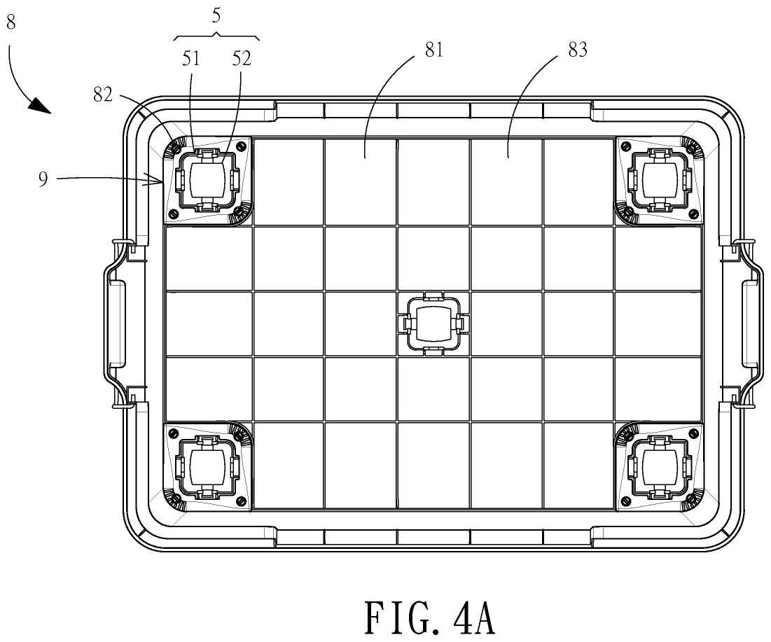

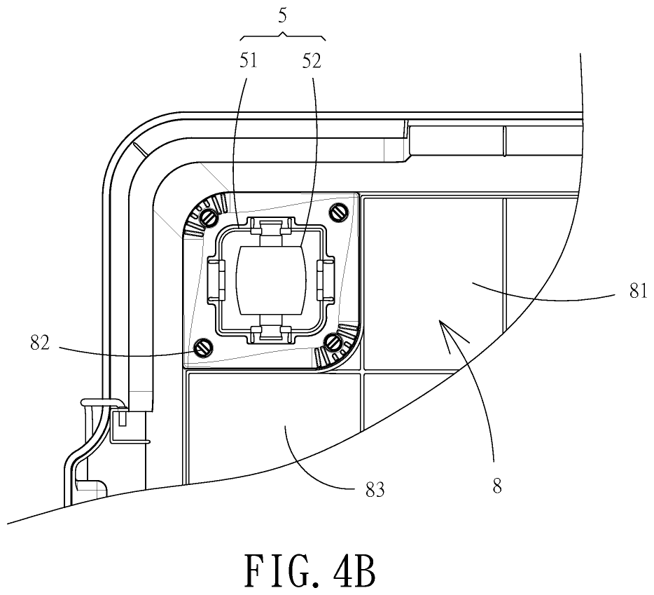

In addition to the specific embodiments of the reinforcing member 9 mentioned above, specific embodiments for storage box 8 having the said reinforcing member 9 will further be provided as following. As shown in FIG. 3A to FIG. 4B, the present disclosure provides specific embodiments for the reinforcing member 9 applied to a storage box 8.

As shown in FIG. 4A, in this embodiment, the storage box 8 comprises a box body 83 and a reinforcing member 9. As shown in FIG. 3A to FIG. 3C, in some embodiments, the box body 83 includes a bottom surface 81, and the bottom surface 81 includes a positioning structure 82 which is used to connect with the positioning portion 32 of the reinforcing member 9. In this embodiment, the positioning structure 82 is a tenon. In other embodiments, the connection method between the reinforcing member 9 and the positioning structure 82 may be, for example but not limited to, screw locking, bonding, matching, fitting, etc.

As shown in FIG. 3C, in this embodiment, the positioning structure 82 is nearly in a mushroom-shape, and a mushroom head 821 of the positioning structure 82 has an interstice 822 reserved. When the mushroom head 821 is squeezed by an external force from outside to inside, the maximum outer diameter of the mushroom head 821 will decrease, so that the mushroom head 821 can pass through the end of the positioning portion 32 close to the bottom surface 81, and when the external force is eliminated, the outer diameter will restore to the original outer diameter and then can be restricted against a barbed part 321 of the inner wall of the positioning portion 32.

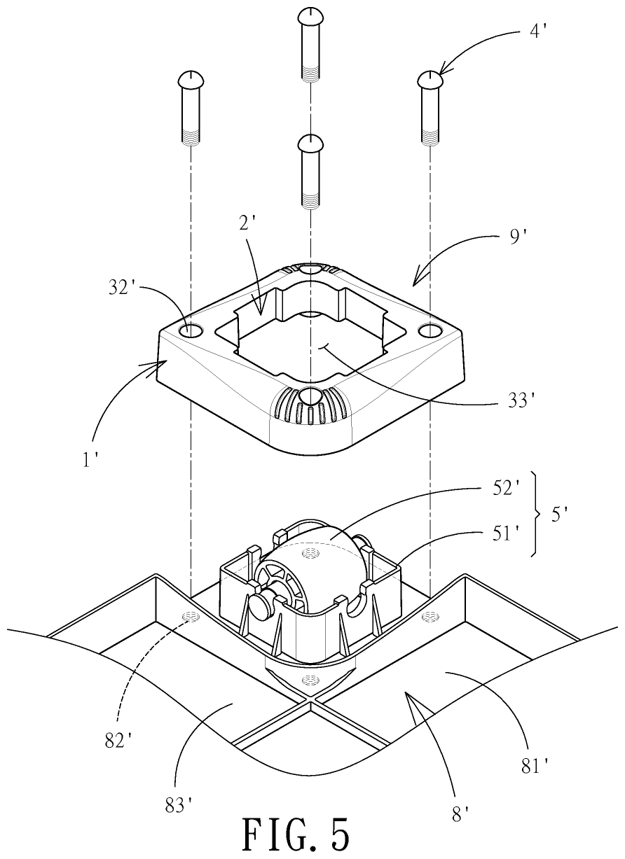

FIG. 5 shows another embodiment to fix the reinforcing member and the storage box. As shown in FIG. 5, in some embodiments, a storage box 8′ comprises a box body 83′, a reinforcing member 9′ and a fixing member 4′. The structure of storage box 8′ shown in FIG. 5 is similar to storage box 8 shown in FIG. 3B, and the structure of reinforcing member 9′ shown in FIG. 5 is similar to reinforcing member 9 shown in FIG. 3B. However, the fixing method between storage box 8′ and reinforcing member 9′ is different from the fixing method between storage box 8 and reinforcing member 9. In this embodiment, the storage box 8′ assemble the box body 83′ and the reinforcing member 9′ by means of screw locking. The fixing member 4′ is detachably connected to a bottom surface 81′ of the box body 83′ being used to allow the reinforcing member 9′ to be fixed to the bottom surface 81′. As shown in FIG. 5, compared to the embodiments mentioned above (namely the embodiments shown in FIG. 3A to FIG. 4B), in this embodiment, a positioning structure 82′ is a hollow with screw threads and the fixing member 4′ is a screw bolt with corresponding threads. The reinforcing member 9′ is fixed to the positioning structure 82′ by using the fixing member 4′ to pass through its positioning portion 32′.

As shown in FIG. 3A to FIG. 4B, in some embodiments, the reinforcing member 9 is connected to a corner of the bottom surface 81. As shown in FIG. 3A and FIG. 4A, in this embodiment, four corners of the bottom surface 81 of the storage box 8 all connect with the reinforcing members 9.

As mentioned above, in this embodiment, the reinforcing member 9 is roughly in a shape of symmetrically lozenge, and the reinforcing member 9 includes two circular arc angle boundaries 11 and two non-circular arc angle boundaries 12. In particular, when the reinforcing member 9 is connected to the corner of the bottom surface 81, one of the circular arc angle boundaries 11 will be correspondingly located at the junction of two adjacent sides of the bottom surface 81, that is to say, the circular arc angle boundary 11 will make the bottom corner of the storage box 8 smooth so as to reduce the sharpness, improving the user's tactile sensation and dispersing the pressure created from being collided by an external force.

More especially, different from conventional storage boxes that are difficult to reinforce specific parts of the boxes due to be limited by uniqueness of materials and shapes of molds because of manufacturing from plastic injection and being integrally formed, the reinforcing member 9 and the storage box 8 can be made from different materials depending on manufacturers' different requirements because of being configured separately and being selectively connected to each other. For example, the box bodies can be made from materials that has lower cost or lighter plastics to keep better production efficiency and lower manufacturing cost, etc., and the reinforcing members 9 can be made from materials (e.g., metals, alloys, and fiberglass reinforced plastics) which is stronger to allow the bottom corner of the storage box 8 to be stronger than the other parts, which solves the problem that the bottom corner of the conventional storage box is more likely to be damaged when being collided or being squeezed by an external force.

As shown in FIG. 1B, FIG. 3A to FIG. 3B, and FIG. 4A to FIG. 4B, in some embodiments, a hollow part 33 (as shown in FIG. 3B) of the reinforcing member 9 further comprises a roller assembly 5. The roller assembly 5 comprises a wheel seat 51 connected to the bottom surface 81 of the storage box 8 and a roller 52, wherein the roller 52 is used to improve the convenience of carrying or moving the storage box 8 by the user. As shown in FIG. 3B, in this embodiment, the wheel seat 51 includes a first notch part 511 and a second notch patch 512, and the user may assemble the roller 52 with the first notch part 511 along a first direction L1 (as shown in FIG. 3B) or assemble the roller 52 with the second notch part 512 along a second direction L2. In this embodiment, the first direction L1 is perpendicular to the second direction L2. The user can selectively assemble the roller 52 along the first direction L1 or along the second direction L2 with the wheel seat 51 depending on the requirement.

The reinforcing member 9 is roughly in a shape of a frame as mentioned above, and then the hollow part 33 is the hollow area surrounded by the said frame. In this embodiment, the roller assemblies 5 located at the four corners of the bottom surface 81 are correspondingly disposed with the hollow parts 33. In particular, the reinforcing member 9 not only provide the effects of collision avoidance and buffer, but also provide the effect of protecting the roller assemblies 5 to reduce the rate of wear and tear under using.

It should be clarified again that the reinforcing member 9 in this invention is not limited to be applied to the storage box 8, it may also be applied to other article, for example, but not limited to, a tool box, a packing box or a suitcase depending on a user's requirement and different situations.

In conclusion, the present disclosure provides a reinforcing member. The reinforcing member is roughly in a shape of a frame including a first annular structure and a second annular structure. There is a positioning portion between the first annular structure and the second annular structure. The positioning portion is used to allow the reinforcing member to be connected to or fixed to part of other articles so as to provide the effect of reinforcement, collision avoidance or buffer.

In addition, because the reinforcing member is roughly in a shape of a symmetrically lozenge, the complexity of the mold may be simplified, and the efficiency of the manufacturing process may be improved.

Lastly, a circular arc angle boundary makes the bottom corner of the storage box to reduce the sharpness, improving a user's tactile sensation and dispersing the pressure created from being collided by an external force.

The above embodiment is only illustrative, and not restrictive. Any equivalent amendments or changes to the above embodiments without deviating from the spirit and scope of this disclosure should also fall within the scope of the patent application attached.

What is claimed is:

1. A reinforcing member, being applied to a storage box and roughly in a shape of a frame, comprising:
a first annular structure, a second annular structure, and a positioning portion; the thickness of the second annular structure being not greater than the thickness of the first annular structure, and the second annular structure being surrounded by the first annular structure; a gap being between the first annular structure and the second annular structure, wherein the gap length of the gap not shorter than 0.5 cm and the positioning portion is disposed in the gap,
wherein the storage box includes a box body, wherein the box body has a positioning structure on the bottom surface of the box body, and wherein the positioning structure is used to connected to the positioning portion of the reinforcing member.

2. The reinforcing member according to claim 1, wherein the thickness of the first annular structure is between 1 cm and 5 cm.

3. The reinforcing member according to claim 1, wherein the first annular structure is roughly in a shape of lozenge that includes a circular arc angle boundary and a non-circular arc angle boundary.

4. The reinforcing member according to claim 3, wherein the first annular structure has at least two circular arc angle boundaries, and the said circular arc angle boundaries are respectively arranged on both sides of a virtual bisector plane of the non-circular arc angle boundary.

5. The reinforcing member according to claim 4, wherein the reinforcing member is symmetrical with respect to the virtual bisector plane.

6. The reinforcing member according to claim 1, wherein at least 70% of the surface of the second annular structure is parallel to the surface of the first annular structure.

7. A storage box, comprising:
a reinforcing member, being roughly in a shape of a frame; the reinforcing member including a first annular structure, a second annular structure, and a positioning portion, wherein the thickness of the second annular structure is not greater than the thickness of the first annular structure, and the second annular structure is surrounded by the first annular structure, wherein there is a gap between the first annular structure and the second annular structure and the gap length of the gap is not shorter than 0.5 cm, and wherein the positioning portion is disposed in the gap, and
a box body, having a positioning structure at a corner of the bottom surface of the box body, and the positioning structure being used to connected to the positioning portion of the reinforcing member,
wherein the reinforcing member is connected to the positioning structure.

8. The storage box according to claim 7, further comprising a fixing member, wherein the fixing member is detachably connected to the bottom surface and the fixing member is used to allow the reinforcing member to be fixed to the bottom surface.

9. The storage box according to claim 7, wherein a hollow part of the reinforcing member further comprises a roller assembly.
